(19) United States
(12) Patent Application Publication
(10) Pub. No.: US 2018/0322001 A1
(43) Pub. Date: Nov. 8, 2018

(54) METHODS FOR OPERATING MULTICORE PROCESSORS

(71) Applicant: SIEMENS AKTIENGESELLSCHAFT, München (DE)

(72) Inventors: Michael Armbruster, München (DE); Christian Buckl, Wangen (DE); Ludger Fiege, Grafing (DE); Andreas Zirkler, München (DE); Martin Bischoff, Holzkirchen (DE)

(21) Appl. No.: 15/773,774

(22) PCT Filed: Oct. 21, 2016
(86) PCT No.: PCT/EP2016/075381

§ 371 Date: May 4, 2018

(30) Foreign Application Priority Data
Nov. 12, 2015 (DE) 10 2015 222 321.3

(51) Int. Cl. G06F 11/07; G06F 11/30; G06F 11/34

(52) U.S. Cl. CPC G06F 11/0724; G06F 11/0772; G06F 11/3433; G06F 11/3017; G06F 11/0754

(57) ABSTRACT

The disclosure relates to at least two processor cores of a multicore processor for dual-lane computing of a security-critical application. The two processor cores are used to full capacity in different working cycles for computing operations of different applications, rather than computing operations being redundantly carried out by both processor cores in each computing cycle. This advantageously avoids duplication of the computational capacity required. For the processor cores to monitor each other, the computing operations are alternatingly carried out by the two processor cores. Any errors may be avoided by the error detection mechanisms described. Although the quality of the error detection is somewhat lower than the “dual-lane operation” known from the prior art with parallel, redundant multi-lane calculations, the quality of the error detection may satisfy the requirement of lower computational outlay, (e.g., when an economic implementation of the control system is required). The disclosure therefore combines the requirements of a sufficiently secure error detection with an economic distribution of the computational capacity.

The present patent document is a § 371 nationalization of PCT Application Serial Number PCT/EP2016/075381, filed Oct. 21, 2016, designating the United States, which is hereby incorporated by reference, and this patent document also claims the benefit of DE 10 2015 222 321.3, filed Nov. 12, 2015, which is also hereby incorporated by reference.

### TECHNICAL FIELD

The disclosure relates to a method for operating a multicore processor.

### BACKGROUND

Modern and future vehicles are equipped with a multiplicity of electronically controlled functions which impose increased requirements on the control system of the vehicle with regard to their security and availability.

Highly secure and highly available control systems based on duplex control computers (DCC), which may be used to provide fail-safe execution of software functions, are currently used. For this purpose, identical software is executed on two independent microprocessors. The peripheral functions of the microprocessors, (that is to say non-volatile and volatile memory units, network connection units, resource managers, etc.), are also carried out on two separate processing paths which are also referred to as “lanes” of a “dual-lane” processing method. The results of the two microprocessors are mutually interchanged at particular times and are compared with one another in both microprocessors.

If an error occurs in one of these so-called lanes or in their communication connection, a differing result is detected in at least one of the lanes with this comparison. Consequently, the duplex control computer is considered to be defective and switches off. It is therefore guaranteed that an incorrect control signal is not emitted by a duplex control computer and a “fail silent” behavior is therefore achieved. Even a “fail operational” behavior may be achieved by providing a further duplex control computer which undertakes the processing of the first duplex control computer in the event of an error in the latter. This error detection probability, which is provided by dual-lane operation using two independently working processors, is achieved by a high hardware outlay.

### SUMMARY AND DESCRIPTION

The scope of the present disclosure is defined solely by the appended claims and is not affected to any degree by the statements within this summary. The present embodiments may obviate one or more of the drawbacks or limitations in the related art.

The disclosure is based on the object of providing an apparatus and a method for implementing a control system with a high degree of availability and integrity which requires a lower outlay on hardware and, at the same time, makes it possible to optimally use the hardware resources.

The method provides for operation of a multicore processor, on which an application which may be security-critical and include a plurality of cyclical computing operations is executed. The term “cyclical computing operations” includes, in particular, a multistage calculation of controlled variables, in which digitized manipulated variables are supplied to the control system at discrete times, are calculated there in a synchronous manner and are output as a digital output signal. A temporally measured working cycle, which may be smaller than a smallest time constant of an underlying control circuit, is provided for the purpose of calculating a respective computing operation.

The disclosure provides for a distribution scheme to be provided, according to which a calculation of a computing operation is supplied to a core of the multicore processor. After a result of a current computing operation has been received, at least one distance between the current result and at least one result of a computing operation at least one working cycle behind is determined within the current working cycle and on the basis of a comparison scheme. If at least one distance is outside an expected value, an error indication is output. A subsequent computing operation is then calculated on another core of the multicore processor which is allocated according to the distribution scheme.

The processor cores of a multicore processor are used for a multichannel calculation of a security-critical application, the processor cores being changed in each working cycle.

As a result of the comparison of at least one distance between the current result and at least one result of a computing operation at least one working cycle behind on the basis of a comparison scheme, random errors may be detected. Although the quality of the error detection is somewhat below that in “dual-lane operation” which is known from the prior art and has a parallel-redundant multichannel calculation, the quality of the error detection may take second place to the requirement for a lower outlay on computing power, in particular if an economic implementation is required for the control system. The disclosure therefore combines requirements imposed on sufficiently reliable error detection with an economic design of the computing power.

Computing operations for other security-critical or non-security-critical applications may be advantageously carried out on the other processor cores, which are currently not encumbered with the processing of the security-critical application, with the result that there is no noticeable additional demand for computing power overall despite the multichannel calculation. In particular, doubling of the computing power required, which is known from the prior art in dual-lane operation with a redundant calculation on one processor core in each case, is avoided.

According to one configuration, the computing operations are each alternately allocated to one of the cores of the multicore processor. In certain examples, in particular when operating dual-core or multicore processors with a two-channel calculation of the security-critical application, the processor cores are changed in each working cycle.

The configurations explained below are based on a multistage comparison scheme which is based on the following considerations: if an error occurs in an exemplary working cycle i in a first processor core or in a memory assigned to the first processor core, the result calculated by this first processor core is corrupted. In a subsequent working cycle i+1, the second processor core now calculates an uncorrupted result. In the working cycle i+2, a corrupted result is again calculated in the first processor core. In each working cycle, the distance between the current result and at least one result lagging behind is compared on each of the two processor cores. In this case, an error may be determined at the earliest in the working cycle i and at the latest in the working cycle i+2.

One configuration provides a comparison scheme, according to which a first distance is determined from the result of a computing operation one working cycle behind and the result of the current working cycle. If this first distance exceeds a maximum value or, in other words, is outside a value expected for the first distance, an error indication is output. According to this configuration, a miscalculation of a processor core is detected in the working cycle i in the case of a two-channel calculation of the security-critical application on a respectively changing processor core, in the case of which miscalculation the result calculated by one processor core differs from the result calculated by the other processor core in the working cycle i−1 to the effect that the current result has a distance from the other result which is outside a predefinable maximum value or maximum distance.

The consistency check based on the comparison scheme is not carried out with respect to bit identity, as in the dual-lane operation known from the prior art, for instance. The reason for this is that input data from successive working cycles are also used for computing operations in successive working cycles. Because the input data from successive working cycles may be different, the results or output data may also differ by a permissible distance. A permissible maximum distance may be predefinable for this permissible distance or, alternatively or additionally, a permissible distance may be calculated from the distances between the results from working cycles lagging behind. The last-mentioned calculation of a permissible distance from the distances between the results from working cycles lagging behind is explained in the following configurations.

Random errors may be detected by the measures described herein. If the same software is executed on different processor cores, systematic errors may not be detected. This also applies, moreover, to the dual-lane operation known in the prior art.

If systematic errors are also intended to be detected, it is known practice in the prior art to execute different software, which therefore very likely does not contain the same error, on two processors of a dual-lane computer. In this case, the second software may have either the same range of functions as the first or may carry out a simplified calculation. The latter is also referred to as an envelope function. In both cases, only the results may be compared, rather than a bit identity, even in the case of the dual-lane computer. Both methods mentioned may be advantageously combined with the present method. For this purpose, the application A1 would be executed in cycle i on core C1 and the application A2 would be executed in cycle i+1 on core C2. In the error-free case, the described error detection would function without change, possibly with an increased permissible delta. If one of the applications is an envelope function in particular, a larger delta will need to be provided, as is also conventional in the prior art. As a result of the variety of the functions, the described error detection mechanisms in this embodiment would also be able to detect errors or differences in the applications A1 and A2.

According to one configuration, further distances and differences between results of computing operations lagging behind are determined in the working cycle i+1, wherein: a second distance is determined from the result of a computing operation two working cycles behind and the result of the current working cycle; and/or a third distance is determined from the result of a computing operation two working cycles behind and the result of a computing operation one working cycle behind; and/or a first difference is determined from a difference between the result of the computing operation one working cycle behind and the result of the current working cycle; and/or a second difference is determined from a difference between the result of the computing operation two working cycles behind and the result of the computing operation one working cycle behind.

According to one configuration, an error indication is output when: (1) the second distance is shorter than the first distance; (2) the second distance is shorter than the third distance; and (3) the first difference has a sign which differs from the second difference.

According to this configuration, a miscalculation of a processor core is detected in the working cycle i+1 in the case of a two-channel calculation of the security-critical application on a respectively changing processor core, in which miscalculation the results calculated by one processor core systematically differ from the results calculated by the other processor core. In this case, the second distance between the results calculated in the working cycles i−1 and i+1 is shorter than the first distance between the results from the working cycles i and i+1 and shorter than the third distance between the results from the working cycles i−1 and i. In addition, the first difference between the results from the working cycles i−1 and i has a sign which differs from the second difference between the results from the working cycles i and i+1.

According to one configuration, further distances and differences between results of computing operations lagging behind are determined in the working cycle i+2, wherein: a fourth distance is determined from the result of a computing operation three working cycles behind and the result of a computing operation one working cycle behind; and/or a fifth distance is determined from the result of a computing operation three working cycles behind and the result of a computing operation two working cycles behind; and/or a third difference is determined from a difference between the result of the computing operation three working cycles behind and the result of the computing operation two working cycles behind.

According to one configuration, an error indication is output when: (1) the second distance is shorter than the first distance; (2) the second distance is shorter than the third distance; (3) the fourth distance is shorter than the third distance; (4) the fourth distance is shorter than the fifth distance; (5) the first difference has a sign which differs from the third difference; and (6) the third difference has a sign which differs from the second difference.

According to this configuration, a miscalculation of a processor core is detected in the working cycle i+2 in the case of a two-channel calculation of the security-critical application on a respectively changing processor core, in which miscalculation the results calculated by one processor core systematically differ from the results calculated by the other processor core. In this case, the second distance between the results calculated in the working cycles i and i+2 is shorter than the first distance between the results from the working cycles i+1 and i+2 and shorter than the third distance between the results from the working cycles i and i+1.

Furthermore, the fourth distance between the results calculated in the working cycles i−1 and i+1 is shorter than the third distance between the results from the working cycles i and i+1 and shorter than the fifth distance between the results from the working cycles i−1 and i.

In addition, the first difference between the results from the working cycles i and i+1 has a sign which differs from the third difference between the results from the working cycles i−1 and i, the third difference in turn having a sign which differs from the second difference between the results from the working cycles i and i+1.

One configuration provides a comparison scheme which provides for a determination of at least one distance and a comparison with preceding distances and/or differences in each working cycle. Alternatively, a determination of distances or differences and/or their comparison take(s) place only in reserved working cycles, for example in every fourth or nth working cycle. Furthermore, the comparison cycles may also be increased according to the comparison scheme if the results respectively determined for each processor core drift apart and/or move in the direction of a limit value.

### BRIEF DESCRIPTION OF THE DRAWINGS

Further exemplary embodiments and advantages of the disclosure are explained in more detail below on the basis of the drawings, in which:

FIG. 1 depicts an example of a schematic illustration of results of two computing operations which are each calculated in alternation for discrete working cycles, in which a respective expected range of values for a distance between a current result and a subsequent result is plotted.

FIG. 2 depicts an example of a schematic illustration of results of two computing operations which are each calculated in alternation for discrete working cycles, in which a respective distance between a current result and a subsequent result is plotted.

FIG. 3 depicts an example of a schematic illustration of results of two computing operations over time, wherein the underlying computing operation contains an integrating control element.

FIG. 4 depicts an example of a schematic illustration of results of two computing operations which are each calculated in alternation for discrete working cycles at a first sampling rate, wherein the underlying computing operation contains an integrating control element.

FIG. 5 depicts an example of a schematic illustration of results of two computing operations which are each calculated in alternation for discrete working cycles at a second sampling rate, wherein the underlying computing operation contains an integrating control element.

### DETAILED DESCRIPTION

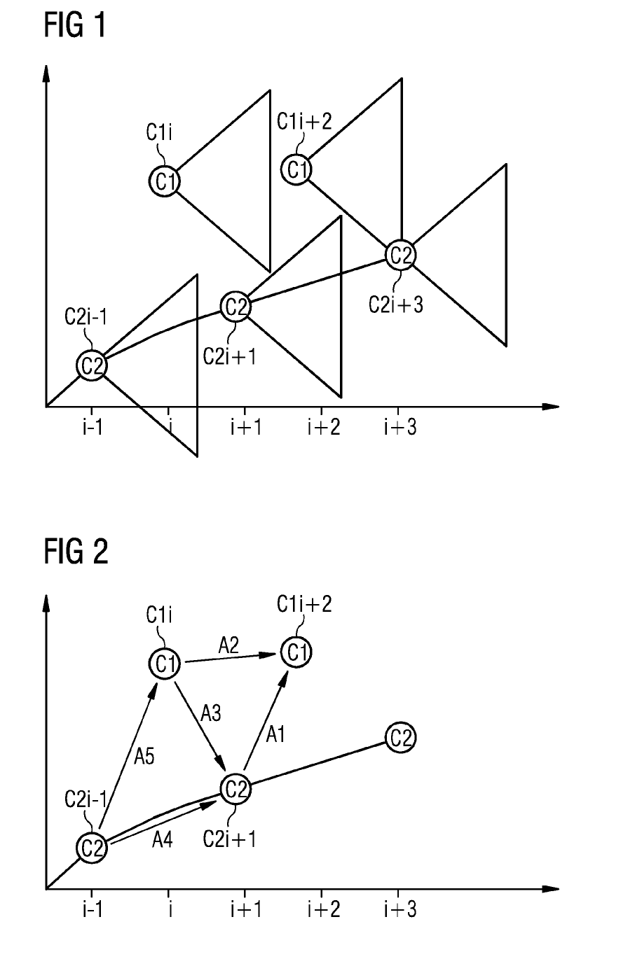

FIG. 1 and FIG. 2 depict a timing diagram, on the ordinate of which results C2i-1, C1i, C2i+1, C1i+2, C2i+3 of two computing operations each calculated in alternation by one of two processor cores, (with a respective corresponding reference symbol prefix C1 for a first processor core and C2 for a second processor core), at discrete times are plotted. The discrete times plotted on the abscissa correspond to working cycles i−1, i, i+1, i+2, i+3.

In FIG. 1, a respective expected range of values for a distance between a current result and a subsequent result is plotted, see the triangular region starting from a respective punctiform result value C2i−1, C1i, C2i+1, C1i+2, C2i+3.

The processor cores which cyclically process the two substantially identical computing operations are changed in each working cycle i−1, i, i+1, i+2, i+3. A processor core not involved in the processing of the computing operation in each case may therefore process other tasks, with the result that no redundant computing power is wasted. At the same time, errors in the processing of the computing operation also affect the respective other computing operation on the other processor core.

If an error occurs in a processor core C1 or in a memory assigned to the processor core C1, (e.g., in the working cycle i), the result C1i calculated by this processor core C1 is corrupted. In the next working cycle i+1, the other processor core C2 now calculates a result C2i+1 which is uncorrupted this time.

In the next working cycle i+2, a corrupted result C1i+2 is again calculated in the processor core C1. According to one configuration of the comparison scheme, the following monitoring mechanisms are provided in both processor cores C1, C2 and may determine that an error is present at the earliest in the working cycle i and at the latest in the working cycle i+2.

In the working cycle i, a first distance between the results C1i and C2i+1 calculated in the working cycles i and i+1 exceeds a maximum value according to FIG. 1. In other words, the result C2i+1 calculated in the working cycle i+1 is outside the triangular region of a value expected for a maximum distance.

In the working cycle i+1, the second distance between the results C2-i and C2i+1 calculated in the working cycles i−1 and i+1 is shorter than the first distance between the results C1i and C2i+1 calculated in the working cycles i and i+1. Furthermore, the second distance between the results C2i−1 and C2i+1 calculated in the working cycles i−1 and i+1 is shorter than the third distance between the results C2i−1 and C1i calculated in the working cycles i−1 and i. In addition, the first difference between the results from the working cycles i−1 and i, that is to say (C2i−1)-(C1i), has a sign which differs from the second difference between the results from the working cycles i and i+1, that is to say (C1i-C2i+1).

In the working cycle i+2, the second distance between the results C1i and C1i+2 calculated in the working cycles i and i+2 is shorter than the first distance between the results C2i+1 and C1i+2 calculated in the working cycles i+1 and i+2 and is shorter than the third distance between the results C1i and C2i+1 calculated in the working cycles i and i+1. Furthermore, the fourth distance between the results C2i−1 and C2i+1, which is calculated in the working cycles i−1 and i+1, is shorter than the third distance between the results C1i and C2i+1, which is calculated in the working cycles i and i+1, and is shorter than the fifth distance between the results C1i and C2i−1, which is calculated in the working cycles i−1 and i. In addition, the first difference between the results (C1i)-(C2i+1) calculated in the working cycles i and i+1 has a sign which differs from the third difference between the results (C2i−1)-(C1i) calculated in the working cycles i−1 and i, in which case the third difference in turn has a sign which differs from the second difference between the results (C1i)-(C2i+1) calculated in the working cycles i and i+1.

FIG. 2 depicts the first distance A1, the second distance A2, the third distance A3, the fourth distance A4, and the fifth distance A5.

If there is no rule for a maximum gradient, it may therefore be reliably detected that there is an error only in the working cycle i+2. Depending on requirements, this test may be carried out continuously in every working cycle or in every nth cycle, for example.

In addition, it is also possible to define closer maximum distances which may be exceeded once or several times before an error is detected. The consistency check may not be carried out for bit identity, as in “true” dual-lane operation, because the two processor cores use the input data from successive cycles for the calculations in successive working cycles.

Because the input data will be different in successive working cycles, possibly limited by a predefined maximum distance, the output data may also differ by a permissible delta. A permissible value may be known for this delta or may be calculated from the distances between the input data.

The advantage is a halving of the computing power required without increasing a cycle time of a digital controller implemented with an application in comparison with the two-channel calculation. Although this reduces the quality of the consistency check, (delta consistency instead of bit identity), and slows down the error response by up to two working cycles, the cycle time of the controller is not increased in comparison with the two-channel calculation in the error-free case.

According to further embodiments, additional measures are taken if the application at least partially implements a digital controller which contains at least partially integrating control elements. That is to say, controllers with I components or past system states are otherwise concomitantly included in the calculation.

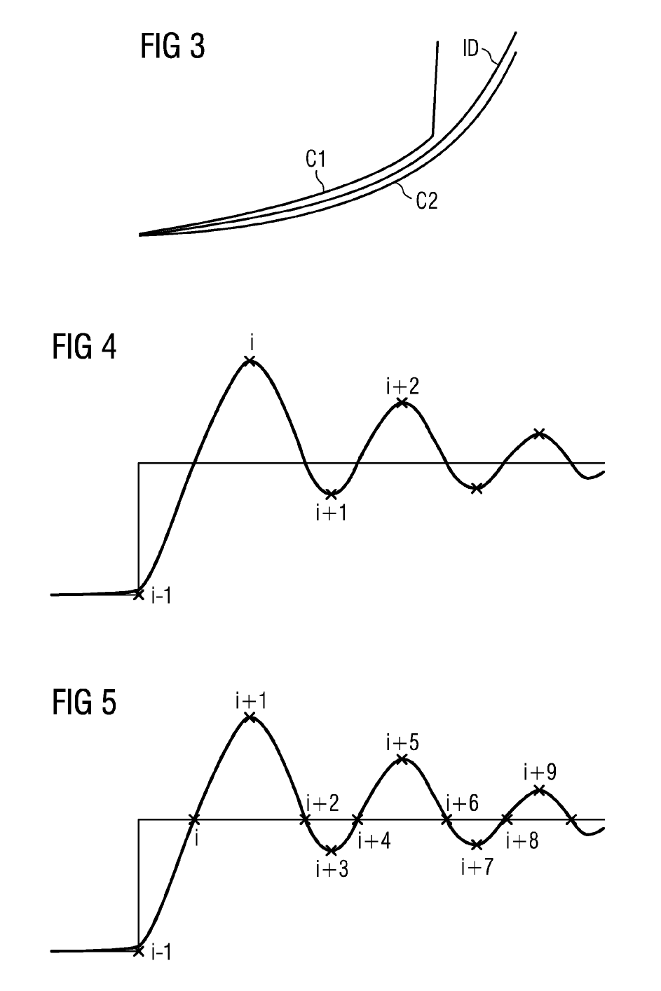

FIG. 3 depicts a schematic illustration of two respective results of a computing operation which are determined by a first processor core C1 and by a second processor core C2 over time, wherein the underlying computing operation contains an integrating control element. Whereas the course of results determined by the second processor core C2 substantially follows an ideal value course ID of the computing operation, the course of results determined by the first processor core C1 drifts away.

Because both processor cores or a plurality of processor cores receive slightly different input values, the output values may likewise be slightly different. This is permissible within the scope of the delta consistency check. However, if the control aims of the two processor cores are slightly above and below the ideal value, the integrator variables in the two processor cores may increase continuously because each processor core sees a slight deviation in the same direction.

This may result in jitter of a controlled assembly because the two controllers provide ever greater control in opposite directions. A critical situation is reached as soon as the integrator variables in one of the controllers reach a limit value, (e.g., the value range limit of the variables). One of the controllers may now no longer provide appropriate counter-control and the control value drifts away. Although this would result in safe disconnection under the conditions described above, the system would no longer be reliable because the changing of the processor cores produces the error in this case. In order to avoid this problem, suitable drift compensation may be provided. For this purpose, the values from the integrators in the two processing paths may be mutually interchanged, for example. In order to avoid possible error propagation, it is advisable to limit the interchanged values from the integrators. The integrator values which are permissible during normal operation may be determined from the dynamic response of the control section and the design of the controller. Limitation of the integrator values is not critical because, in the worst-case scenario, it may result in a slowing-down of the controller behavior, but not in an instability.

Instabilities may occur if the input signal of the controller oscillates at a frequency which is similar to the working cycle frequency, that is to say the reciprocal value of a temporal value of the working cycle. This may result in an excessively high value being transferred to one processor core and an excessively low value being transferred to the other processor core at the controller input and the manipulated variables oscillating according to FIG. 4 as a result. This behavior would be detected as an error according to the above rules and may therefore be avoided.

The following configurations are suitable for this purpose.

Avoidance of undersampling: Controllers may be configured in such a manner that the sampling rate is considerably higher than the frequency of the controlled variables. Factors of four or more have been tried and tested in operation, cf. FIG. 5. This measure may be used in all control sections, the dynamic response of which is sufficiently well known.

Change of the processor core in a “waltz time cycle” or similar discontinuous changes: if the dynamic response of the control section is not known, the rhythm at which the processor cores are changed may be altered. For example, the calculation of a computing operation may be supplied to the first processor core C1 twice and may then be supplied to the second processor core C2 once. The asymmetrical period duration when changing the processor cores may not result in a frequency of a controller variable which results in the behavior described above in combination with unwanted error detection.

Use of a three-core or multicore processor: For example, the calculation of a computing operation may be supplied to a first processor core C1 once, may then be supplied to a second processor core C2 and may then be supplied to a third processor core C3. An error in one of the processor cores may therefore be distinguished from oscillating input data because an error in one of the processor cores would occur only in every third cycle.

Integrator value feedback with limitation of the valid range of values for integrator values which have been fed back, as stated above.

Comparison of system states with history: if system states are calculated from a number of values from the past, different input data may also result in different results when calculating these system states. In order to avoid error detection here, either temporal deltas may be allowed when calculating these error states or the states may be interchanged between the processing paths.

As an alternative to the methods described above, both processing paths may access the same memory area according to an alternative configuration. All historical data, integrator values, etc. for both processing paths would therefore be identical and none of the above mechanisms would be required. The price for this simplification is that the shared memory area becomes a common error cause area. For some applications, this may be acceptable if the probability of undiscovered errors in the common error cause area is sufficiently low as a result of suitable measures, (e.g., error-correcting code (ECC) or memory scrambling).

At least two processor cores of a multicore processor are used to calculate a security-critical application in two channels. In this case, the computing operations are not redundantly calculated in each computing cycle on both processor cores, but rather both processor cores are used with different applications in different working cycles. Doubling of the computing capacity required is therefore advantageously avoided. In order to achieve mutual monitoring of the processor cores, the computing operations are alternately calculated on both processor cores. Random errors may be detected by the error detection mechanisms described. Although the quality of the error detection is somewhat below that in “dual-lane operation” which is known from the prior art and has a parallel-redundant multichannel calculation, the quality of the error detection may take second place to the requirement for a lower outlay on computing power, in particular if an economic implementation is required for the control system. The disclosure therefore combines requirements imposed on sufficiently reliable error detection with an economic design of the computing power.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for operating a multicore processor on which an application comprising a plurality of cyclical computing operations is executed, wherein a temporally measured working cycle is provided for calculating a respective computing operation, the method comprising:
calculating a computing operation on a processor core of the multicore processor which is allocated according to a distribution scheme;
determining at least one distance between a current result of the computing operation and at least one result of a computing operation at least one working cycle behind within a current working cycle and based on a comparison scheme;
outputting an error indication when at least one distance is outside an expected value; and
calculating a subsequent computing operation on a processor core of the multicore processor which is allocated according to the distribution scheme.

2. The method of claim 1, wherein the computing operations are each alternately allocated to one processor core of the multicore processor according to the distribution scheme.

3. The method of claim 1, wherein an allocation to a first processor core of the multicore processor for a predefinable plurality of working cycles is provided according to the distribution scheme before the allocation is changed to a second processor core of the multicore processor.

4. The method of claim 3, wherein, when the error indication is output, the plurality of working cycles for allocation to the first processor core is increased.

5. The method of claim 2, wherein the computing operations are each allocated to one of at least three processor cores of the multicore processor in a rotating manner.

6. The method of claim 1, wherein a first distance is determined from the previous result of the computing operation of the one working cycle behind and the result of the current working cycle according to the comparison scheme.

7. The method of claim 6, wherein the error indication is output when the first distance is outside a value expected for the first distance.

8. The method of claim 6, further comprising one or more of the following:
determining a second distance from a result of a computing operation two working cycles behind and the result of the current working cycle;
determining a third distance from the result of a computing operation two working cycles behind and the result of the computing operation one working cycle behind;
determining a first difference from a difference between the result of the computing operation one working cycle behind and the result of the current working cycle;
determining a second difference from a difference between the result of the computing operation two working cycles behind and the result of the computing operation one working cycle behind.

9. The method of claim 8, wherein the error indication is output when:
the second distance is shorter than the first distance;
the second distance is shorter than the third distance; and
the first difference has a sign which differs from the second difference.

10. The method of claim 8, further comprising:
determining a fourth distance from a result of a computing operation three working cycles behind and the result of the computing operation one working cycle behind;
determining a fifth distance from the result of the computing operation three working cycles behind and the result of the computing operation two working cycles behind;
determining a third difference from a difference between the result of the computing operation three working cycles behind and the result of the computing operation two working cycles behind.

11. The method of claim 10, wherein the error indication is output when:
the second distance is shorter than the first distance;
the second distance is shorter than the third distance;
the fourth distance is shorter than the third distance;
the fourth distance is shorter than the fifth distance;
the first difference has a sign which differs from the third difference; and
the third difference has a sign which differs from the second difference.

12. The method of claim 1, wherein at least one distance is determined for each working cycle according to the comparison scheme.

13. The method of claim 1, wherein at least one distance is determined for every n^{th} working cycle according to the comparison scheme, where n is a natural number.

14. A computer program product configured to, when executed by the at least one multicore processor in a control system, cause the control system to perform:
calculate a computing operation on a processor core of the multicore processor which is allocated according to a distribution scheme;
determine at least one distance between a current result of the computing operation and at least one result of a computing operation at least one working cycle behind within a current working cycle and based on a comparison scheme;
output an error indication when at least one distance is outside an expected value; and
calculate a subsequent computing operation on a separate processor core of the multicore processor which is allocated according to the distribution scheme.

15. The method of claim 2, wherein an allocation to a first processor core of the multicore processor for a predefinable plurality of working cycles is provided according to the distribution scheme before the allocation is changed to a second processor core of the multicore processor.

16. The method of claim 15, wherein, when the error indication is output, the plurality of working cycles for allocation to the first processor core is increased.

17. The method of claim 3, wherein the computing operations are each allocated to one of at least three processor cores of the multicore processor in a rotating manner.

18. The method of claim 2, wherein a first distance is determined from the previous result of the computing operation of the one working cycle behind and the result of the current working cycle according to the comparison scheme.
